(19) United States
(12) Patent Application Publication
(10) Pub. No.: US 2022/0053525 A1
(43) Pub. Date: Feb. 17, 2022

(54) TERMINAL DEVICE, BASE-STATION DEVICE, AND COMMUNICATION METHOD

(71) Applicants: SHARP KABUSHIKI KAISHA, Sakai City, Osaka (JP); FG Innovation Company Limited, Tuen Mun (HK)

(72) Inventors: TAEWOO LEE, Sakai City, Osaka (JP); SHOICHI SUZUKI, Sakai City, Osaka (JP); WATARU OUCHI, Sakai City, Osaka (JP); TOMOKI YOSHIMURA, Sakai City, Osaka (JP); TOSHIZO NOGAMI, Sakai City, Osaka (JP); HUI-FA LIN, Sakai City, Osaka (JP)

(21) Appl. No.: 17/267,007

(22) PCT Filed: Jul. 19, 2019
(86) PCT No.: PCT/JP2019/028539

§ 371 Date: Feb. 8, 2021

(30) Foreign Application Priority Data
Aug. 8, 2018 (JP) 2018-149241

(51) Int. Cl. H04W 72/12; H04L 1/00

(52) U.S. Cl. CPC H04W 72/1268; H04L 1/0061; H04W 72/1226; H04W 72/1289

(57) ABSTRACT

Uplink transmission can be performed efficiently. A transmission unit that transmits performance information and/or a PUSCH of a terminal device is provided. CSI-Part2 that is multiplexed in the PUSCH is dropped until a code rate of the CSI-Part2 becomes equal to or less than a target code rate of the CSI-Part2, and the code rate of the CSI-Part2 is determined based on a calculation performance of decimal places supported in the performance information of the terminal device.

### FIELD

The present invention relates to a terminal device, a base-station device, and a communication method. Priority for the present application is asserted based on JP 2018-149241 filed in Japan on Aug. 8, 2018, the content thereof being hereby included by citation.

### BACKGROUND

The 3rd Generation Partnership Project (3rd Generation Partnership Project: 3GPP) is studying a radio access method and radio network in cellular mobile communication (hereinbelow referred to as “Long Term Evolution (LTE: registered trademark)” or “Evolved Universal Terrestrial Radio Access: EUTRA”). 3GPP is also studying a new radio access method (hereinbelow referred to as “New Radio (NR)”) (non-patent literatures 1, 2, 3, 4). In LTE, a base-station device is also referred to as an eNodeB (evolved NodeB). In NR, a base-station device is also referred to as a gNodeB. In LTE and NR, a terminal device is also referred to as UE (user equipment). LTE and NR are cellular communication systems that dispose a plurality of areas covered by a base-station device as cells. A single base-station device may manage a plurality of cells.

In NR, one serving cell is set to have a downlink BWP (bandwidth part) and an uplink BWP as a set (non-patent literature 3). A terminal device receives a PDCCH and a PDSCH in the downlink BWP.

### PRIOR-ART LITERATURE

### Non-Patent Literature

Non-patent literature 1: “3GPP TS 38.211 V15.1.0 (2018 June), NR; Physical channels and modulation”, R1-1807955, 6 Jun. 2018.
Non-patent literature 2: “3GPP TS 38.212 V15.1.1 (2018 May), NR; Multiplexing and channel coding”, R1-1807956, 29th May, 2018.
Non-patent literature 3: “3GPP TS 38.213 V15.1.0 (2018 May), NR; Physical layer procedures for control”, R1-1807957, 31 May 2018.
Non-patent literature 4: “3GPP TS 38.214 V15.1.0 (2018 June), NR; Physical layer procedures for data”, R1-1807958, 6 Jun. 2018.

### SUMMARY

### Problem to be Solved by Invention

One aspect of the present invention provides a terminal device that communicates efficiently, a communication method used in this terminal device, a base-station device that communicates efficiently, and a communication method used in this base-station device.

### Means for Solving Problem

(1) A first aspect of the present invention is a terminal device, provided with: a transmission unit that transmits performance information and/or a PUSCH of the terminal device; wherein CSI-Part2 that is multiplexed in the PUSCH is dropped until a code rate of the CSI-Part2 becomes equal to or less than a target code rate of the CSI-Part2, and the code rate of the CSI-Part2 is determined based on a calculation performance of decimal places supported in the performance information of the terminal device.

(2) A second aspect of the present invention is a base-station device, provided with: a reception unit that receives performance information and/or a PUSCH of a terminal device; wherein it is assumed that CSI-Part2 that is multiplexed in the PUSCH is dropped until a code rate of the CSI-Part2 becomes equal to or less than a target code rate of the CSI-Part2, and comparison is performed by taking into account a number of decimal places relating to the code rate and the target code rate based on the performance information of the terminal device.

(3) A third aspect of the present invention is a communication method used in a terminal device, provided with: a step of transmitting performance information and/or a PUSCH of the terminal device; wherein CSI-Part2 that is multiplexed in the PUSCH is dropped until a code rate of the CSI-Part2 becomes equal to or less than a target code rate of the CSI-Part2, and the code rate of the CSI-Part2 is determined based on a calculation performance of decimal places supported in the performance information of the terminal device.

(4) A fourth aspect of the present invention is a communication method used in a base-station device, provided with: a step of receiving performance information and/or a PUSCH of a terminal device; wherein it is assumed that CSI-Part2 that is multiplexed in the PUSCH is dropped until a code rate of the CSI-Part2 becomes equal to or less than a target code rate of the CSI-Part2, and comparison is performed by taking into account a number of decimal places relating to the code rate and the target code rate based on the performance information of the terminal device.

### Effects of Invention

According to this invention, the terminal device can communicate efficiently. Moreover, the base-station device can communicate efficiently.

### BRIEF DESCRIPTION OF THE DRAWINGS

FIG. 1 A conceptual diagram of a radio communication system of the present embodiment.

FIG. 2 A diagram illustrating a schematic configuration of a radio frame of the present embodiment.

FIG. 3 A diagram illustrating a schematic configuration of an uplink slot in the present embodiment.

FIG. 4 A schematic block diagram illustrating a configuration of a terminal device 1 of the present embodiment.

FIG. 5 A schematic block diagram illustrating a configuration of a base-station device 3 of the present embodiment.

FIG. 6 A diagram illustrating a flowchart that derives a number of coded modulation symbols of a UCI payload transmitted in a PUSCH not accompanied by an UL-SCH in the present embodiment.

FIG. 7 A diagram illustrating one example of decimal calculation performances of the terminal device 1 and the base-station device 3 in the present embodiment.

FIG. 8 A diagram illustrating one example of candidates of C_{mcs} imparted at least based on a DCI format in the present embodiment.

### EMBODIMENTS OF INVENTION

An embodiment of the present invention is described below.

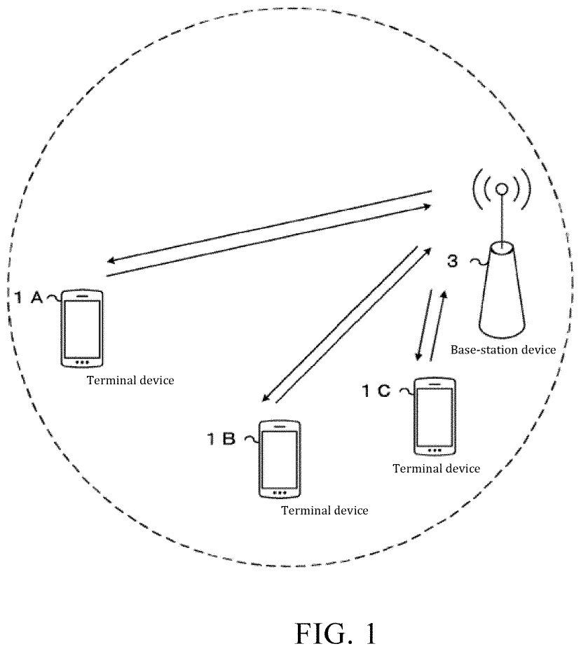

FIG. 1 is a conceptual diagram of a radio communication system of the present embodiment. In FIG. 1, the radio communication system is provided with terminal devices 1A to 1C and a base-station device 3. Hereinbelow, the terminal devices 1A to 1C are referred to as a terminal device 1.

Physical channels and physical signals of the present embodiment are described.

In uplink radio communication from the terminal device 1 to the base-station device 3, the following uplink physical channels are used. The uplink physical channels are used to transmit information output from a higher layer.

PUCCH (physical uplink control channel)

PUSCH (physical uplink shared channel)

PRACH (physical random access channel)

The PUCCH is used by the terminal device 1 to transmit uplink control information (uplink control information: UCI) to the base-station device 3. Note that in the present embodiment, the terminal device 1 may perform PUCCH transmission in a primary cell and/or a secondary cell having a function of the primary cell and/or a secondary cell capable of PUCCH transmission. That is, the PUCCH may be transmitted in a defined serving cell.

The uplink control information includes at least one among downlink channel state information (channel state information: CSI), a scheduling request (scheduling request: SR) indicating a PUSCH resource request, and a HARQ-ACK (hybrid automatic repeat request acknowledgment) for downlink data (transport block, medium access control protocol data unit: MAC PDU, downlink-shared channel: DL-SCH, physical downlink shared channel: PDSCH).

When the downlink data is successfully decoded, an ACK is generated for this downlink data. When the downlink data is not successfully decoded, a NACK is generated for this downlink data. DTX (discontinuous transmission) may signify that no downlink data is detected. DTX may signify that no data for which to transmit a HARQ-ACK response is detected. The HARQ-ACK may at least include HARQ-ACK bits at least corresponding to one transport block. The HARQ-ACK bits may indicate an ACK (acknowledgement) or NACK (negative acknowledgment) corresponding to one transport block or a plurality of transport blocks. The HARQ-ACK may at least include a HARQ-ACK codebook including one HARQ-ACK bit or a plurality of HARQ-ACK bits. The HARQ-ACK bits corresponding to the one transport block or the plurality of transport blocks may be the HARQ-ACK bits corresponding to a PDSCH including this one transport block or plurality of transport blocks.

The HARQ-ACK may also be referred to as an ACK/NACK, HARQ feedback, HARQ-ACK feedback, a HARQ response, a HARQ-ACK response, HARQ information, HARQ-ACK information, HARQ control information, and HARQ-ACK control information.

The HARQ-ACK bits may indicate an ACK or NACK corresponding to one CBG (code block group) included in a transport block.

The channel state information (CSI: channel state information) may include a channel quality indicator (CQI: channel quality indicator) and a rank indicator (RI: rank indicator). The channel quality indicator may include a precoder matrix indicator (PMI: precoder matrix indicator) and a CSI-RS indicator (CRI: CSI-RS resource indicator). The channel state information may include the precoder matrix indicator. The CQI is an indicator relating to channel quality (propagation strength), and the PMI is an indicator that instructs a precoder. The RI is an indicator that instructs a transmission rank (or number of transmission layers). The CSI may also be referred to as a CSI report and CSI information. The transmission layers may be referred to as layers.

The CSI report may be one report or may be divided into a plurality of reports. For example, when the CSI report is divided in two, a first CSI report after division may be CSI-Part1, and a second CSI report after division may be CSI-Part2. A size of the CSI report may be a bit count of a portion or an entirety of the divided CSI. The size of the CSI report may be a bit count of CSI-Part1. The size of the CSI report may be a bit count of CSI-Part2. The size of the CSI report may be a sum total of bit counts of a plurality of divided CSI reports. The sum total of the bit counts of the plurality of divided CSI is a bit count of the CSI report prior to dividing. CSI-Part1 may include a portion or an entirety of any among at least the RI, CRI, CQI, and PMI. CSI-Part2 may include a portion or an entirety of any among the PMI, CQI, RI, and CRI. The size of the CSI report may be set so as to not exceed a predetermined threshold (predetermined bit count).

A scheduling request (SR: scheduling request) may at least be used to request a PUSCH resource for an initial transmission. Scheduling request bits may be used to indicate either a positive SR (positive SR) or a negative SR (negative SR). The scheduling request bits indicating a positive SR is also referred to as a “positive SR being transmitted”. The positive SR may indicate that a PUSCH resource for an initial transmission is requested by the terminal device 1. The positive SR may indicate that a scheduling request is triggered by a higher layer. The positive SR may be transmitted when a higher layer instructs transmitting a scheduling request. The scheduling request bits indicating a negative SR is also referred to as a “negative SR being transmitted”. The negative SR may indicate that a PUSCH resource for an initial transmission is not requested by the terminal device 1. The negative SR may indicate that a scheduling request is not triggered by a higher layer. The negative SR may be transmitted when a higher layer does not instruct transmitting a scheduling request.

The scheduling request bits may be used to indicate either a positive SR or a negative SR for either one SR configuration (SR configuration) or a plurality of SR configurations. This one SR configuration or plurality of SR configurations may respectively correspond to one logical channel or a plurality of logical channels. A positive SR for a certain SR configuration may be a positive SR for any or all among one logical channel or a plurality or logical channels corresponding to this certain SR configuration. The negative SR does not have to correspond to a specific SR configuration. A negative SR being indicated may be a negative SR being indicated for all SR configurations.

The SR configuration may be a scheduling request ID (scheduling request ID).

The PUSCH may be used to transmit uplink data. The PUSCH may be used to transmit the HARQ-ACK and/or the channel state information together with the uplink data. Moreover, the PUSCH may be used to transmit only the channel state information or only the HARQ-ACK and/or the channel state information. That is, the PUSCH may be used to transmit the uplink control information. The terminal device 1 may transmit the PUSCH based on detection of a PDCCH (physical downlink control channel) including an uplink grant (uplink grant). The uplink data may at least include a portion or an entirety of a transport block (transport block), a medium access control protocol data unit (MAC PDU: medium access control protocol data unit), and a UL-SCH (uplink-shared channel).

The PRACH is used to transmit a random-access preamble (random-access message 1). The PRACH may be used to indicate at least a portion of an initial connection establishment (initial connection establishment) procedure, a handover procedure, a connection reestablishment (connection reestablishment) procedure, synchronization (timing adjustment) of uplink data transmissions, and PUSCH (UL-SCH) resource requests.

In uplink radio communication from the terminal device 1 to the base-station device 3, the following uplink physical signal may be used. The uplink physical signal does not have to be used to transmit information output from a higher layer but is used by the physical layer.

Uplink reference signal (UL RS: uplink reference signal)

At least the following two types of uplink reference signals may at least be used in the present embodiment.

DMRS (demodulation reference signal)

SRS (sounding reference signal)

The DMRS relates to PUSCH and/or PUCCH transmission. The DMRS may be multiplexed along with the PUSCH or the PUCCH. The base-station device 3 uses the DMRS to perform propagation channel correction for the PUSCH or the PUCCH. Hereinbelow, transmission of the PUSCH and the DMRS together is simply called transmission of the PUSCH. This DMRS may correspond to this PUSCH. Hereinbelow, transmission of the PUCCH and the DMRS together is simply called transmission of the PUCCH. This DMRS may correspond to this PUCCH.

The SRS does not have to relate to PUSCH and/or PUCCH transmission. The SRS may relate to PUSCH and/or PUCCH transmission. The base-station device 3 may use the SRS to measure a channel state. The SRS may be transmitted from an end in an uplink slot in a predetermined number—one or a plurality—of OFDM symbols.

In downlink radio communication from the base-station device 3 to the terminal device 1, the following downlink physical channels may be used. The downlink physical channels may be used by the physical layer to transmit information output from a higher layer.

PBCH (physical broadcast channel)

PDCCH (physical downlink control channel)

PDSCH (physical downlink shared channel)

The PBCH is used to broadcast a master information block (MIB: master information block) used in common in one terminal device 1 or a plurality of terminal devices 1 in a serving cell, an active BWP (bandwidth part), or a carrier. The PBCH may be transmitted based on a predetermined transmission interval. For example, the PBCH may be transmitted at intervals of 80 ms. At least a portion of the information included in the PBCH may be updated every 80 ms. In the frequency domain, the PBCH may be constituted by a predetermined number of subcarriers (for example, 288 subcarriers). Moreover, in the time domain, the PBCH may be configured by including two, three, or four OFDM symbols. The MIB may include information relating to an identifier (index) of a synchronization signal. The MIB may include information instructing at least a portion of a number of a slot, a number of a subframe, and a number of a radio frame whereto the PBCH is transmitted. First setting information may be included in the MIB. This first setting information may be setting information that is at least used in a portion or an entirety of random-access message 2, random-access message 3, and random-access message 4.

The PDCCH is used to transmit downlink control information (DCI: downlink control information). The downlink control information is also referred to as a DCI format. Note that the DCI format may be configured by including one field or a plurality of fields of downlink control information. The downlink control information may at least include either an uplink grant (uplink grant) or a downlink grant (downlink grant).

The uplink grant may be used for scheduling of a single PUSCH in a single cell. The uplink grant may be used for scheduling of a plurality of PUSCH in a plurality of slots in a single cell. The uplink grant may be used for scheduling of a single PUSCH in a plurality of slots in a single cell. Downlink control information including the uplink grant may also be referred to as an uplink-related DCI format.

One downlink grant is at least used for scheduling of one PDSCH in one serving cell. The downlink grant is at least used for scheduling of a PDSCH in the same slot as a slot whereto this downlink grant is transmitted. Downlink control information including the downlink grant may also be referred to as a downlink-related DCI format.

The PDSCH is used to transmit the downlink data (TB, MAC PDU, DL-SCH, PDSCH, CB, CBG). The PDSCH is at least used to transmit random-access message 2 (random-access response). The PDSCH is at least used to transmit system information including parameters used for initial access.

The BCH, UL-SCH, and DL-SCH above are transport channels. A channel used in the medium access control (MAC: medium access control) layer is referred to as a transport channel. A unit of the transport channel used in the MAC layer is also referred to as a transport block or a MAC PDU. In the MAC layer, HARQ (hybrid automatic repeat request) control is performed for each transport block. The transport block is a unit of data delivered (delivered) by the MAC layer to the physical layer. In the physical layer, the transport block is mapped onto a code word, and modulation processing is performed for each code word.

The base-station device 3 and the terminal device 1 may exchange (transmit and receive) signals in a higher layer (higher layer). For example, the base-station device 3 and the terminal device 1 may transmit and receive RRC signaling (also referred to as an RRC message [a Radio Resource Control message] or RRC information [Radio Resource Control information]) in the Radio Resource Control (RRC: Radio Resource Control) layer. Moreover, the base-station device 3 and the terminal device 1 may transmit and receive a MAC CE (medium access control control element) in the MAC layer. Here, the RRC signaling and/or the MAC CE is also referred to as higher-layer signaling (higher-layer signaling).

The PUSCH and/or the PDSCH is at least used to transmit the RRC signaling and the MAC CE. Here, the RRC signaling transmitted from the base-station device 3 in the PDSCH may be RRC signaling shared by a plurality of terminal devices 1 in a cell. RRC signaling shared by a plurality of terminal devices 1 in a cell is also referred to as shared RRC signaling. The RRC signaling transmitted from the base-station device 3 in the PDSCH may be RRC signaling dedicated to a certain terminal device 1 (also referred to as dedicated signaling or UE-specific signaling). RRC signaling dedicated to a terminal device 1 is also referred to as dedicated RRC signaling. Cell-specific parameters may be transmitted using RRC signaling shared by a plurality of terminal devices 1 in a cell or RRC signaling dedicated to a certain terminal device 1. UE-specific parameters may be transmitted using RRC signaling dedicated to a certain terminal device 1.

A configuration of a radio frame (radio frame) of the present embodiment is described below.

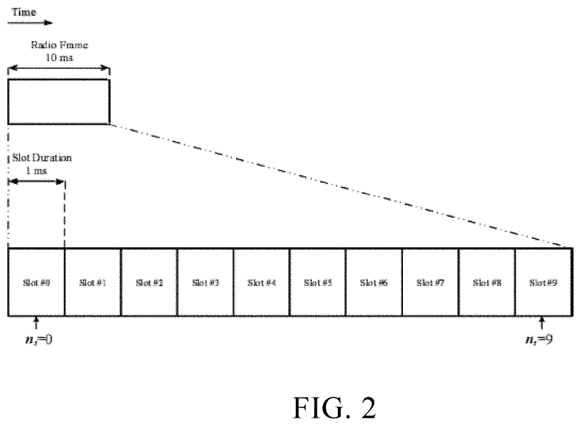

FIG. 2 is a diagram illustrating a schematic configuration of the radio frame in the present embodiment. In FIG. 2, the horizontal axis is a time axis. Each radio frame may be 10 ms long. Moreover, each radio frame may be constituted from ten slots. Each slot may be 1 ms long.

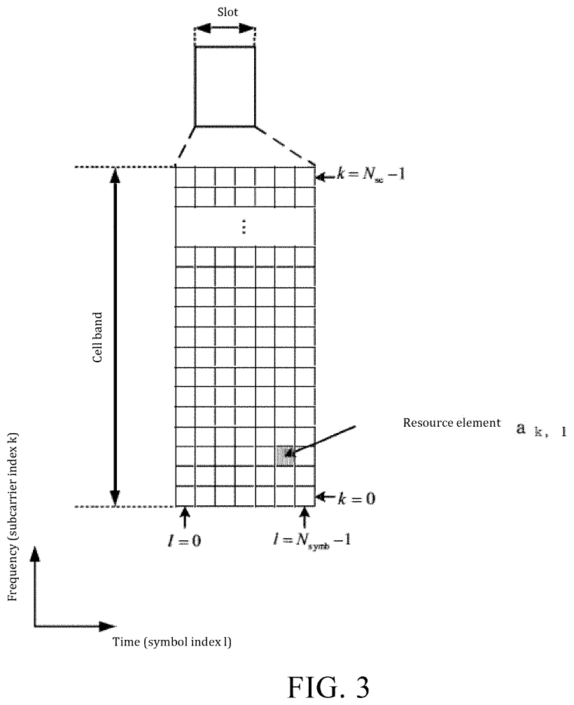

One example of a configuration of a slot of the present embodiment is described below. FIG. 3 is a diagram illustrating a schematic configuration of an uplink slot in the present embodiment. FIG. 3 illustrates a configuration of an uplink slot in one cell. In FIG. 3, the horizontal axis is a time axis, and the vertical axis is a frequency axis. The uplink slot may include N^{UL}_{symb} SC-FDMA symbols. The uplink slot may include N^{UL}_{symb} OFDM symbols. Hereinbelow, the present embodiment is described using a situation wherein the uplink slot includes OFDM symbols. However, the present embodiment can also be applied to a situation wherein the uplink slot includes SC-FDMA symbols.

In FIG. 3, l is an OFDM symbol number/index, and k is a subcarrier number/index. A physical signal or physical channel transmitted in each slot is expressed by a resource grid. In uplink, the resource grid is defined by a plurality of subcarriers and a plurality of OFDM symbols. Each element in the resource grid is referred to as a resource element. The resource element is represented by the subcarrier number/index k and the OFDM symbol number/index l.

In the time domain, the uplink slot may include a plurality of OFDM symbols l (l=0, 1, . . . , N^{UL}_{symb}−1). In one uplink slot, N^{UL}_{symb} may be 7 or 14 for a normal CP (normal cyclic prefix) in uplink. N^{UL}_{symb} may be 6 or 12 for an extended CP (extended cyclic prefix) in uplink.

The terminal device 1 receives from the base-station device 3 an upper-layer parameter UL-CyclicPrefixLength indicating a CP length in uplink. The base-station device 3 may broadcast, within a cell, system information including the upper-layer parameter UL-CyclicPrefixLength corresponding to this cell.

In the frequency domain, the uplink slot may include a plurality of subcarriers k (k=0, 1, . . . , N^{UL}_{RB}·N^{RB}_{SC}−1). N^{UL}_{RB} is an uplink bandwidth setting for a serving cell and is expressed as a multiple of N^{RB}_{SC}. N^{RB}_{SC} is a (physical) resource block size in the frequency domain expressed as the number of subcarriers. A subcarrier interval Δf may be 15 kHz. N^{RB}_{SC} may be 12. The (physical) resource block size in the frequency domain may be 180 kHz.

One physical resource block is defined by N^{UL}_{symb} continuous OFDM symbols in the time domain and N^{RB}_{SC} continuous subcarriers in the frequency domain. As such, one physical resource block is constituted from (N^{UL}_{symb}·N^{RB}_{SC}) resource elements. One physical resource block may correspond to one slot in the time domain. In the frequency domain, the physical resource blocks may be labeled using a number n_{PRB} (0, 1, . . . , N^{UL}_{RB}−1) in order of lowest frequency.

A downlink slot in the present embodiment includes a plurality of OFDM symbols. A configuration of the downlink slot in the present embodiment is basically identical to that of the uplink. As such, description of the configuration of the downlink slot is omitted.

A configuration of a device in the present embodiment is described below.

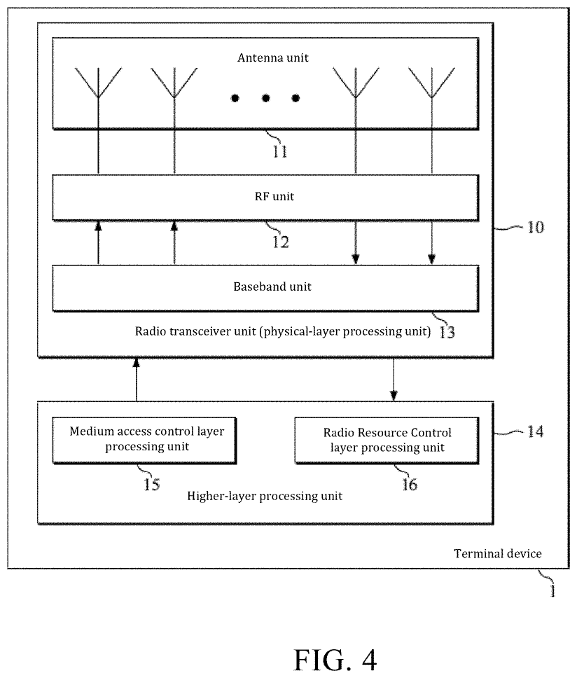

FIG. 4 is a schematic block diagram illustrating a configuration of the terminal device 1 of the present embodiment. As illustrated, the terminal device 1 is configured by including a radio transceiver unit 10 and a higher-layer processing unit 14. The radio transceiver unit 10 is configured by including an antenna unit 11, an RF (radio frequency) unit 12, and a baseband unit 13. The higher-layer processing unit 14 is configured by including a medium access control layer processing unit 15 and a Radio Resource Control layer processing unit 16. The radio transceiver unit 10 is also referred to as a transmission unit, a reception unit, an encoding unit, a decoding unit, or a physical-layer processing unit.

The higher-layer processing unit 14 outputs uplink data (transport block) generated by a user operation or the like to the radio transceiver unit 10. The higher-layer processing unit 14 performs processing of the medium access control (MAC: medium access control) layer, the Packet Data Convergence Protocol (Packet Data Convergence Protocol: PDCP) layer, the Radio Link Control (Radio Link Control: RLC) layer, and the Radio Resource Control (Radio Resource Control: RRC) layer.

The medium access control layer processing unit 15 provided by the higher-layer processing unit 14 performs processing of the medium access control layer. The medium access control layer processing unit 15 controls a random access order based on various setting information/parameters managed by the Radio Resource Control layer processing unit 16.

The Radio Resource Control layer processing unit 16 provided by the higher-layer processing unit 14 performs processing of the Radio Resource Control layer. The Radio Resource Control layer processing unit 16 manages various setting information/parameters of its own device. The Radio Resource Control layer processing unit 16 sets the various setting information/parameters based on higher-layer signaling received from the base-station device 3. That is, the Radio Resource Control layer processing unit 16 sets the various setting information/parameters based on information indicating the various setting information/parameters received from the base-station device 3.

The radio transceiver unit 10 performs physical-layer processing such as modulation, demodulation, encoding, and decoding. The radio transceiver unit 10 separates, demodulates, and decodes a signal (physical channel and/or physical signal) received from the base-station device 3 and outputs the decoded information to the higher-layer processing unit 14. The radio transceiver unit 10 generates a transmission signal (physical channel and/or physical signal) by modulating and encoding data and transmits this to the base-station device 3.

The RF unit 12 converts (down-converts: down-converts) a signal received via the antenna unit 11 into a baseband signal by quadrature demodulation and removes unnecessary frequency components. The RF unit 12 outputs the processed analog signal to the baseband unit.

The baseband unit 13 converts the analog signal input from the RF unit 12 from an analog signal into a digital signal. The baseband unit 13 removes a portion corresponding to the CP (cyclic prefix) from the converted digital signal and subjects the signal removed of the CP to a fast Fourier transform (fast Fourier transform: FFT) to extract a frequency-domain signal.

The baseband unit 13 subjects data to an inverse fast Fourier transform (inverse fast Fourier transform: IFFT) to generate an SC-FDMA symbol, adds a CP to the generated SC-FDMA symbol, generates a baseband digital signal, and converts the baseband digital signal into an analog signal. The baseband unit 13 outputs the converted analog signal to the RF unit 12.

The RF unit 12 uses a low-pass filter to remove unnecessary frequency components from the analog signal input from the baseband unit 13, up-converts (up-converts) the analog signal to a carrier frequency, and transmits this via the antenna unit 11. Moreover, the RF unit 12 amplifies power. Moreover, the RF unit 12 may be provided with a function of controlling transmission power. The RF unit 12 is also referred to as a transmission-power control unit.

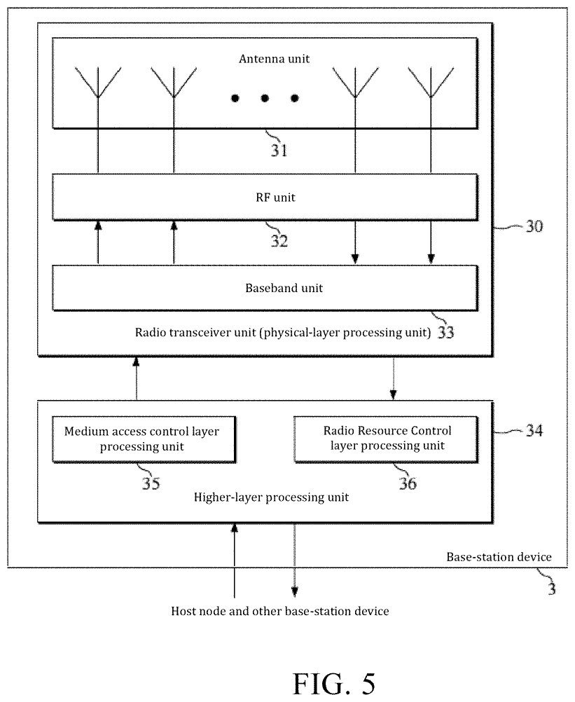

FIG. 5 is a schematic block diagram illustrating a configuration of the base-station device 3 of the present embodiment. As illustrated, the base-station device 3 is configured by including a radio transceiver unit 30 and a higher-layer processing unit 34. The radio transceiver unit 30 is configured by including an antenna unit 31, an RF unit 32, and a baseband unit 33. The higher-layer processing unit 34 is configured by including a medium access control layer processing unit 35 and a Radio Resource Control layer processing unit 36. The radio transceiver unit 30 is also referred to as a transmission unit, a reception unit, an encoding unit, a decoding unit, or a physical-layer processing unit.

The higher-layer processing unit 34 performs processing of the medium access control (MAC: medium access control) layer, the Packet Data Convergence Protocol (Packet Data Convergence Protocol: PDCP) layer, the Radio Link Control (Radio Link Control: RLC) layer, and the Radio Resource Control (Radio Resource Control: RRC) layer.

The medium access control layer processing unit 35 provided by the higher-layer processing unit 34 performs processing of the medium access control layer. The medium access control layer processing unit 35 controls a random access order based on various setting information/parameters managed by the Radio Resource Control layer processing unit 36.

The Radio Resource Control layer processing unit 36 provided by the higher-layer processing unit 34 performs processing of the Radio Resource Control layer. The Radio Resource Control layer processing unit 36 generates, or acquires from a host node, downlink data (transport block), system information, an RRC message, a MAC CE, and the like that are disposed in the physical downlink shared channel and outputs these to the radio transceiver unit 30. Moreover, the Radio Resource Control layer processing unit 36 manages various setting information/parameters of each terminal device 1. The Radio Resource Control layer processing unit 36 may set the various setting information/parameters for each terminal device 1 via higher-layer signaling. That is, the Radio Resource Control layer processing unit 36 transmits/broadcasts information indicating the various setting information/parameters.

Functions of the radio transceiver unit 30 are similar to those of the radio transceiver unit 10. Description thereof is therefore omitted.

Each of the units labeled using reference sign 10 to reference sign 16 provided by the terminal device 1 may be configured as a circuit. Each of the units labeled using reference sign 30 to reference sign 36 provided by the base-station device 3 may be configured as a circuit. Each of the units labeled using reference sign 10 to reference sign 16 provided by the terminal device 1 may be configured as at least one processor and a memory connected to this at least one processor. Each of the units labeled using reference sign 30 to reference sign 36 provided by the base-station device 3 may be configured as at least one processor and a memory connected to this at least one processor.

The radio communication system of the present embodiment may apply TDD (time-division duplexing) and/or FDD (frequency-division duplexing). In a situation of cell aggregation, a serving cell applying TDD and a serving cell applying FDD may be aggregated.

Note that higher-layer signaling may be any among RMSI (remaining minimum system information), OSI (other system information), an SIB (system information block), an RRC message, and a MAC CE. Moreover, higher-layer parameters (higher-layer parameters) may signify parameters and information elements included in higher-layer signaling.

UCI transmitted in the PUSCH may include a HARQ-ACK and/or CSI.

When a DCI format that triggers an aperiodic CSI report for a certain serving cell is successfully decoded, in this serving cell, the terminal device 1 may transmit an aperiodic CSI report (aperiodic CSI report) using the PUSCH. The aperiodic CSI report transmitted using the PUSCH may support wideband (wideband) and/or sub-band (sub-band) frequency granularity (frequency granularity). Moreover, the aperiodic CSI report transmitted in the PUSCH may support type I and/or type II CSI.

When DCI format 0_1, which activates a semi-persistent (semi-persistent) CSI trigger (trigger) state, is successfully decoded, the terminal device 1 may transmit a semi-persistent CSI report. DCI format 0_1 may include a CSI request field instructing whether to activate the semi-persistent CSI trigger state. The semi-persistent CSI report transmitted in the PUSCH may support wideband (wideband) and/or sub-band (sub-band) frequency granularity (frequency granularity). A PUSCH resource and/or an MCS (modulation and coding scheme) may be semi-persistently (semi-persistently) disposed in an uplink DCI format.

The CSI report transmitted in the PUSCH may be multiplexed (multiplexed) along with uplink data transmitted in the PUSCH. Moreover, the CSI report transmitted in the PUSCH may be transmitted even without uplink data. That is, the CSI report may be transmitted in a PUSCH not accompanied by uplink data. Here, the uplink data may be the UL-SCH.

A type I CSI report may be supported by the CSI report transmitted in the PUSCH. Moreover, type I sub-band CSI may be supported by the CSI report transmitted in the PUSCH. Moreover, type II CSI may be supported by the CSI report transmitted in the PUSCH. Note that the CSI report may also be referred to as CSI feedback. Here, being supported by the CSI report may signify being included in the CSI report. Being supported by the CSI report may signify being transmitted by being included in the CSI report.

In type I and/or type II CSI feedback transmitted in the PUSCH, the CSI report may include two parts (CSI-Part1, CSI-Part2).

CSI-Part1 may be used to identify a number of information bits of CSI-Part2. An entirety of this CSI-Part1 may be transmitted before CSI-Part2 is transmitted.

In type I CSI feedback, CSI-Part1 may include a rank indicator (RI) and/or a CRI and/or a CQI of a first code word. In type I and/or type II feedback, CSI-Part1 may be a fixed payload size. Moreover, CSI-Part1 may include the RI, the CQI, and/or an indicator of a number of wideband amplitude coefficients for each layer that is not zero (0) in the type II CSI. CSI-Part1 may be encoded separately from CSI-Part2. CSI-Part2 may include a PMI of the type II CSI.

The type II CSI report transmitted in the PUSCH may be calculated independently, having no relation to the type II CSI report transmitted in PUCCH format 2, PUCCH format 3, and/or PUCCH format 4.

A number of CSI reported by the CSI may be imparted to the terminal device 1 as a higher-layer parameter report quantity. When the higher-layer parameter report quantity is constituted by a value that is either the CSI/RSRP (reference signal received power) and/or an SSBRI (SS/PBCH block resource indicator)/RSRP, CSI feedback may be constituted by one part. That is, when the higher-layer parameter report quantity is constituted by a value that is either the CSI/RSRP and/or the SSBRI/RSRP, CSI feedback may be constituted by CSI-Part1. Moreover, when the higher-layer parameter report quantity is constituted by a value that is either the CSI/RSRP and/or the SSBRI/RSRP, CSI feedback may be constituted by CSI-Part2.

For both a type I report and a type II report transmitted in the PUSCH but configured for the PUCCH, an encoding scheme (encoding scheme) of this PUSCH may follow an encoding scheme of this PUCCH. When a type I report and/or a type II report configured for the PUCCH is transmitted in the PUSCH, the encoding scheme of this PUSCH may follow the encoding scheme of this PUCCH. That is, when a type I report and/or type II report configured for the PUCCH is transmitted in the PUSCH, the encoding scheme of this PUSCH may be a polar code (polar code).

When the CSI report transmitted in the PUSCH is divided in two, the terminal device 1 may omit a portion or an entirety of CSI-Part2. To “omit (omit)” may signify to not transmit and to discard a portion or an entirety of the data according to a rule. This rule may be determined based on a priority level (priority level). Moreover, omitting may also be referred to as dropping (dropping). The omitted data does not need to be mapped onto a resource element. Moreover, being “omitted (omitted)” may signify data not being selected as uplink data according to a rule.

In transmitting HARQ-ACK information in a PUSCH accompanied by the UL-SCH, a number Q′_{ACK} of coded modulation symbols (coded modulation symbols) of each layer for transmitting the HARQ-ACK information may be determined at least based on mathematical formula 1. Here, the coded modulation symbol may be used to derive a length E_{UCI} of a rate-matching output sequence. Moreover, the coded modulation symbol may be a set (group, aggregate) of coded bits. The coded modulation symbol may include the same number of coded bits as a modulation order for the PUSCH. The coded modulation symbol may correspond to a modulation symbol. By modulating one coded modulation symbol, one modulated symbol (complex-value symbol) is obtained. The number of coded modulation symbols may be identical to a number of modulation symbols (complex-value symbols) modulated by a modulation method. This modulation method may be QAM (quadrature amplitude modulation), QPSK (quadrature phase-shift keying), or BPSK (binary phase-shift keying).

$$[ Math . 1 ]$$

$${Q}_{ACK}^{′} = min \{ ccil ( \frac{\begin{matrix}( {O}_{ACK} + {L}_{ACK} ) \cdot {β}_{offset}^{PUSCH} \cdot \\ {\sum }_{l = 0}^{{N}_{symb , all}^{PUSCH} - 1} {M}_{sc}^{UCI} ( l )\end{matrix}}{{\sum }_{r = 0}^{{C}_{UL - SCH} - 1} {K}_{r}} ) , ccil ( α \cdot {\sum }_{l = {l}_{o}}^{{N}_{symb , all}^{PUSCH} - 1} {M}_{sc}^{UCI} ( l ) ) \}$$

O_{ACK} may be a bit count of the HARQ-ACK information. L_{ACK} may be a CRC bit count corresponding to O_{ACK}. L_{ACK} may be a reference CRC bit count corresponding to O_{ACK}. L_{ACK} may differ from a CRC bit count actually transmitted by the terminal device 1. When the bit count of the HARQ-ACK information is less than 12 (that is, O_{ACK}<12), the terminal device 1 may set L_{ACK} to 0. When the bit count of the HARQ-ACK information is equal to or greater than 12 and equal to or less than 19 (that is, 12≤O_{ACK}≤19), the terminal device 1 may set L_{ACK} to 6. When the bit count of the HARQ-ACK information is equal to or greater than 20 and less than 360 (that is, 20≤O_{ACK}<360), the terminal device 1 may set L_{ACK} to 11. Moreover, when the bit count of the HARQ-ACK information is equal to or greater than 360 (that is, 360≤O_{ACK}), the terminal device 1 may set L_{ACK} to 11. α may be imparted at least based on higher-layer parameter scaling. α may be any value among 0.5, 0.65, 0.8, and 1. l₀ may be an index of the first OFDM symbol that does not include a DMRS in the PUSCH. Moreover, ceil(F) is a function that outputs an integer that rounds up a numerical value F to the nearest integer. min{F1,F2} is a function that outputs the smaller value among F1 and F2.

M_{SC}^{UCI}(l) may be a number of resource elements used in UCI transmission by an lth OFDM symbol. M_{SC}^{UCI}(l) may be a number of resource elements that can be used in UCI transmission by the lth OFDM symbol. Here, l may be an integer between 0 and N_{symb,all}^{PUSCH}−1. That is, the relationship may be l=0, 1, 2, . . . , N_{symb,all}^{PUSCH}−1. Moreover, N_{symb,all}^{PUSCH} may be a total number of OFDM symbols used in PUSCH transmission. N_{symb,all}^{PUSCH} may include a number of OFDM symbols used in the DMRS. When the DMRS of the PUSCH is transmitted in the lth OFDM symbol, M_{SC}^{UCI}(l) may be 0. When the DMRS of the PUSCH is not transmitted in the lth OFDM symbol, M_{SC}^{UCI}(l) may be imparted at least based on a value wherein the number of subcarriers of a PT-RS transmitted in the lth OFDM symbol is subtracted from a bandwidth wherein PUSCH transmission expressed by the number of subcarriers is scheduled. That is, the relationship may be M_{SC}^{UCI}(l)=M_{SC}^{PUSCH}−M_{SC}^{PT-RS}(l). Here, M_{SC}^{PUSCH} may be the bandwidth wherein PUSCH transmission expressed by the number of subcarriers is scheduled. Moreover M_{SC}^{PT-RS}(l) may, be the number of subcarriers of the PT-RS transmitted in the lth OFDM symbol.

When a DCI format that schedules PUSCH transmission includes a CBGTI field instructing the terminal device 1 to not transmit an rth code block, Kᵣ may be 0. When the DCI format that schedules PUSCH transmission includes no CBGTI field instructing the terminal device 1 to not transmit the rth code block, Kᵣ may be a size of the rth code block of the UL-SCH in PUSCH transmission. r may be an integer between 0 and C_{UL-SCH}−1. That is, the relationship may be r=0, 1, 2, . . . , C_{UL-SCH}−1. C_{UL-SCH} may be a number of code blocks for the UL-SCH in PUSCH transmission.

β_{offset}^{PUSCH} is an offset value for determining a number of resources to use in multiplexing the HARQ-ACK information and/or multiplexing CSI information in the PUSCH. β_{offset}^{PUSCH} may be signaled to the terminal device 1 by a DCI format that schedules PUSCH transmission that multiplexes the HARQ-ACK information and/or the CSI information, or it may be signaled from a higher layer. This offset value corresponding to the HARQ-ACK information may be β_{offset}^{HARQ-ACK}. This offset value corresponding to CSI-Part1 may be β_{offset}^{CSI-1}. This offset value corresponding to CSI-Part2 may be β_{offset}^{CSI-2}.

When DCI format 0_0 schedules PUSCH transmission in the terminal device 1, the terminal device 1 may apply β_{offset}^{HARQ-ACK} imparted from a higher layer to the HARQ-ACK information corresponding to this offset and/or apply β_{offset}^{CSI-1} imparted from a higher layer to CSI-Part1 corresponding to this offset and/or apply β_{offset}^{CSI-2} imparted from a higher layer to CSI-Part2 corresponding to this offset.

In transmitting the HARQ-ACK information in a PUSCH not accompanied by the UL-SCH, the number Q′_{ACK} of coded modulation symbols of each layer for transmitting the HARQ-ACK information may be determined at least based on mathematical formula 2.

$${Q}_{ACK}^{′} = min \{ ceil ( \frac{( {O}_{ACK} + {L}_{ACK} ) \cdot {β}_{offset}^{PUSCH}}{R \cdot {Q}_{m}} ) , ceil ( α \cdot {\sum }_{l = {l}_{0}}^{{N}_{symb , {all}^{- 1}}^{PUSCH}} {M}_{sc}^{UCI} ( l ) ) \} \qquad [ Math . 2 ]$$

R may be imparted at least based on a DCI format that schedules the PUSCH. R may be imparted at least based on a value included in the DCI format that schedules the PUSCH. R may be a target code rate (target code rate) imparted at least based on the DCI format that schedules the PUSCH. R may be a code rate of the PUSCH. R may be a target code rate (target code rate) of the PUSCH. R may be identical to or different from an actual code rate of the UL-SCH. R may be identical to or different from an actual code rate of the HARQ-ACK. R may be identical to or different from an actual code rate of CSI Part1. R may be identical to or different from an actual code rate of CSI Part2. Moreover, the actual code rate may be a ratio of a payload a and a sum total of a CRC bit count corresponding to this payload a and the length of the rate-matching output sequence. Moreover, a code rate of the UCI may be a ratio of a UCI payload a and a sum total of a CRC bit count corresponding to this UCI payload a and the length of the rate-matching output sequence. The code rate may be a value that is equal to or greater than 0 and equal to or less than 1. Qₘ may be a modulation order (modulation order) of the PUSCH. For example, in 64 QAM, Qₘ is 6. In 16 QAM, Qₘ is 4. In QPSK, Qₘ may be 2. Moreover, in BPSK, Qₘ may be 1.

In mathematical formula 1 and mathematical formula 2, β_{offset}^{PUSCH} may be the higher-layer parameter β_{offset}^{HARQ-ACK} for determining the number of resources to use in multiplexing the HARQ-ACK information in the PUSCH or a value instructed at least based on a DCI format.

In transmitting CSI-Part1 in the PUSCH accompanied by the UL-SCH, a number Q′_{CSI-1} of coded modulation symbols of each layer for transmitting CSI-Part1 may be determined at least based on mathematical formula 3.

$${Q}_{CSI - 1}^{′} = min \{ ceil ( \frac{( {O}_{CSI - 1} + {L}_{CSI - 1} ) \cdot {β}_{offset}^{PUSCH} \cdot {\sum }_{l = 0}^{{N}_{symb , {all}^{- 1}}^{PUSCH}} {M}_{sc}^{UCI} ( l )}{{\sum }_{r = 0}^{{C}_{UL - SCH} - 1} {K}_{r}} ) , ceil ( α \cdot {\sum }_{l = 0}^{{N}_{symb , {all}^{- 1}}^{PUSCH}} {M}_{sc}^{UCI} ( l ) ) - {Q}_{ACK}^{′} \} \qquad [ Math . 3 ]$$

When CSI-Part1 transmitted in the PUSCH not accompanied by the UL-SCH is present and CSI-Part2 transmitted in this PUSCH is present, the number Q′_{CSI-1} of coded modulation symbols of each layer for transmitting CSI-Part1 may be determined at least based on mathematical formula 4.

$$\\ {Q}_{C S I - 1}^{′} = min \{ ceil ( \frac{( {O}_{CSI - 1} + {L}_{CSI - 1} ) \cdot {β}_{Offset}^{PUSCH}}{R \cdot {Q}_{m}} ) , {\sum }_{l = 0}^{{N}_{symb , {all}^{- 1}}^{PUSCH}} {M}_{sc}^{UCI} ( l ) - {Q}_{A C K}^{′} \} \qquad [ Math . 4 ]$$

O_{CSI-1} may be a bit count of CSI-Part1. L_{CSI-1} may be a CRC bit count corresponding to O_{CSI-1}. L_{CSI-1} may be a reference CRC bit count corresponding to O_{CSI-1}. L_{CSI-1} may differ from a CRC bit count actually transmitted by the terminal device 1. When the bit count of CSI-Part1 is less than 12 (that is, O_{CSI-1}<12), the terminal device 1 may set L_{CSI-1} to 0. When the bit count of CSI-Part1 is equal to or greater than 12 and equal to or less than 19 (that is, 12≤O_{CSI-1}≤19), the terminal device 1 may set L_{CSI-1} to 6. When the bit count of CSI-Part1 is equal to or greater than 19 and less than 360 (that is, 20≤O_{CSI-1}<360), the terminal device 1 may set L_{CSI-1} to 11. Moreover, when the bit count of CSI-Part1 is equal to or greater than 360 (that is, 360≤O_{CSI-1}), the terminal device 1 may set L_{CSM-1} to 11.

In mathematical formula 3 and/or mathematical formula 4, β_{offset}^{PUSCH} may be the higher-layer parameter β_{offset}^{CSI-part1} for determining the number of resources to use in multiplexing CSI-Part1 in the PUSCH or a value instructed at least based on a DCI format. When the bit count O_{ACK} of the HARQ-ACK transmitted in the PUSCH is equal to or less than 2 bits, Q′_{ACK} in mathematical formula 3 and mathematical formula 4 may be determined at least based on mathematical formula 5. When the bit count O_{ACK} of the HARQ-ACK transmitted in the PUSCH is greater than 2 bits, Q′_{ACK} in mathematical formula 3 and mathematical formula 4 may be determined at least based on mathematical formula 1 or mathematical formula 2. When the bit count O_{ACK} of the HARQ-ACK transmitted in the PUSCH is greater than 2 bits, Q′_{ACK} in mathematical formula 3 and mathematical formula 4 may be the number of coded modulation symbols of each layer of the HARQ-ACK transmitted in the PUSCH. In mathematical formula 5, M_{sc,rvd}^{ACK}(l) may be a number of resource elements reserved (reserved) for potential (potential) HARQ-ACK transmission in the OFDM symbol l. Q′_{ACK} in mathematical formula 5 may be a sum total of the number of resource elements when the OFDM symbol index l is between 0 and N_{symb,all}^{PUSCH}−1. Hereinbelow, unless specifically indicated otherwise, Q′_{ACK} is the Q′_{ACK} determined at least based on mathematical formula 1 or mathematical formula 2.

$${Q}_{ACK}^{′} = {\sum }_{l = 0}^{{N}_{symb , {all}^{- 1}}^{PUSCH}} {\overline{M}}_{sc , rvd}^{ACK} ( l ) \qquad [ Math . 5 ]$$

When CSI-Part1 transmitted in the PUSCH not accompanied by the UL-SCH is present and CSI-Part2 transmitted in this PUSCH is not present, the number Q′_{CSI-1} of coded modulation symbols of each layer for transmitting CSI-Part1 may be determined at least based on mathematical formula 6.

$${Q}_{CSI - 1}^{′} = {\sum }_{l = 0}^{{N}_{symb , {all}^{- 1}}^{PUSCH}} {M}_{sc}^{UCI} ( l ) - {Q}_{ACK}^{′} \qquad [ Math . 6 ]$$

In transmitting CSI-Part2 in the PUSCH accompanied by the UL-SCH, a number Q′_{CSI-2} of coded modulation symbols of each layer for transmitting CSI-Part2 may be determined at least based on mathematical formula 7.

$${Q}_{CSI - 2}^{′} = min \{ ceil ( \frac{( {O}_{CSI - 2} + {L}_{CSI - 2} ) \cdot {β}_{offset}^{PUSCH} \cdot {\sum }_{l = 0}^{{N}_{symb , {all}^{- 1}}^{PUSCH}} {M}_{sc}^{UCI} ( l )}{{\sum }_{r = 0}^{{C}_{UL - SCH} - 1} {K}_{r}} ) , ceil ( α \cdot {\sum }_{l = 0}^{{N}_{symb , {all}^{- 1}}^{PUSCH}} {M}_{sc}^{UCI} ( l ) ) - {Q}_{ACK}^{′} - {Q}_{CSI - 1}^{′} \} \qquad [ Math . 7 ]$$

O_{CSI-2} may be a bit count of CSI-Part2. L_{CSI-2} may be a CRC bit count corresponding to O_{CSI-2}. L_{CSI-2} may be a reference CRC bit count corresponding to O_{CSI-2}. L_{CSI-2} may differ from a CRC bit count actually transmitted by the terminal device 1. When the bit count of CSI-Part2 is less than 12 (that is, O_{CSI-2}<12), the terminal device 1 may set L_{CSI-2} to 0. When the bit count of CSI-Part2 is equal to or greater than 12 and equal to or less than 19 (that is, 12≤O_{CSI-2}≤19), the terminal device 1 may set L_{CSI-2} to 6. When the bit count of CSI-Part2 is equal to or greater than 20 and less than 360 (that is, 20≤O_{CSI-2}<360), the terminal device 1 may set L_{CSI-2} to 11. Moreover, when the bit count of CSI-Part2 is equal to or greater than 360 (that is, 360≤O_{CSI-2}), the terminal device 1 may set L_{CSI-2} to 11.

In mathematical formula 7, β_{offset}^{PUSCH} may be the higher-layer parameter β_{offset}^{CSI-part2} for determining the number of resources to use in multiplexing CSI-Part2 in the PUSCH or a value instructed at least based on a DCI format. When the bit count O_{ACK} of the HARQ-ACK is equal to or less than 2 bits, Q′_{ACK} in mathematical formula 6 and mathematical formula 7 may be 0. When the bit count O_{ACK} of the HARQ-ACK transmitted in the PUSCH is greater than 2 bits, Q′_{ACK} in mathematical formula 6 and mathematical formula 7 may be determined at least based on mathematical formula 1 or mathematical formula 2. When the bit count O_{ACK} of the HARQ-ACK is greater than 2 bits, Q′_{ACK} in mathematical formula 6 and mathematical formula 7 may be the number of coded modulation symbols of each layer of the HARQ-ACK transmitted in the PUSCH.

In transmitting CSI-Part2 in the PUSCH not accompanied by the UL-SCH, the number Q′_{CSI-2} of coded modulation symbols of each layer for transmitting CSI-Part2 may be determined at least based on mathematical formula 8.

$${Q}_{CSI - 2}^{′} = {\sum }_{l = 0}^{{N}_{symb , {all}^{- 1}}^{PUSCH}} {M}_{sc}^{UCI} ( l ) - {Q}_{ACK}^{′} - {Q}_{CSI - 1}^{′} \qquad [ Math . 8 ]$$

An input bit sequence to rate matching in the code block r may be defined as dᵣ₀, dᵣ₁, dᵣ₂, dᵣ₃, . . . , d_{r(Nr-1)}. Here, r may be an index of the code block. Moreover, Nr may be a total number of coded bits in the code block r. A length Er of the rate-matching output sequence in the code block r may be derived at least based on a total number of code blocks, a layer count N_{L} of the PUSCH, the modulation order, and/or the coded modulation symbols of each layer. An output bit sequence after rate matching may be defined as fᵣ₀, fᵣ₁, fᵣ₂, fᵣ₃, . . . , f_{r(Er-1)}. That is, the length Er of the rate-matching output sequence in the code block r may be imparted at least based on mathematical formula 9.

$${E}_{r} = floor ( \frac{{E}_{UCI}}{{C}_{UCI}} ) \qquad [ Math . 9 ]$$

In mathematical formula 9, C_{UCI} may be a number of code blocks for the UCI payload a. E_{UCI} may be a length of the rate-matching output sequence corresponding to a portion or all of the layers in the layer count N_{L} of the PUSCH. Moreover, E_{UCI} may be imparted at least based on at least the layer count, the number of coded modulation symbols of the UCI payload a, and/or the modulation order. A length of the rate-matching output sequence corresponding to the HARQ-ACK information may be imparted at least based on mathematical formula 10. A length of the rate-matching output sequence corresponding to CSI-Part1 may be imparted at least based on mathematical formula 11. A length of the rate-matching output sequence corresponding to CSI-Part2 may be imparted at least based on mathematical formula 12. In mathematical formula 10, mathematical formula 11, and/or mathematical formula 12, N_{L} may be the layer count. floor(F) is a function that outputs an integer that rounds down the numerical value F to the nearest integer. For example, if F=3.9, floor(F)=3, and if F=5.2, floor(F)=5.

E_{UCI}=N_{L}·Q_{ACK}′·Qₘ [Math. 10]

E_{UCI}=N_{L}·Q_{CSI-1}′·Qₘ [Math. 11]

E_{UCI}=N_{L}·Q_{CSI-2}′·Qₘ [Math. 12]

When the CSI report transmitted in the PUSCH is divided in two, the terminal device 1 may omit a portion or the entirety of CSI-Part2. CSI-Part2 may be omitted according to a priority order (priority order). The priority order may be imparted at least based on a type of the CSI report and a serving-cell index.

When the terminal device 1 is scheduled to transmit uplink data in the PUSCH wherein the CSI report is multiplexed and all UCI code rates for transmitting CSI-Part2 are greater than a threshold code rate (threshold code rate) c_{T}, a portion or the entirety of CSI-Part2 may be omitted. This threshold code rate (threshold code rate) c_{T} of the PUSCH accompanied by the UL-SCH may be imparted at least based on mathematical formula 13. All CSI-Part2 may be CSI-Part2 before a portion or the entirety of CSI-Part2 is omitted. Here, c_{MCS} may be R.

$${c}_{T} = \frac{{c}_{MCS}}{{β}_{offset}^{CSI - 2}} \qquad [ Math . 13 ]$$

When CSI-Part2 is transmitted in a PUSCH not accompanied by uplink data, the terminal device 1 may omit a portion or the entirety of CSI-Part2 based an order of lowest priority order until the code rate of CSI-Part2 becomes equal to or less than the threshold code rate (threshold code rate) c_{T}. That is, the terminal device 1 may first drop a portion or the entirety of CSI-Part2 having a low priority order. The threshold code rate (threshold code rate) c_{T} of when CSI-Part2 is transmitted in the PUSCH not accompanied by uplink data may be imparted at least based on mathematical formula 14.

$${c}_{T} = \frac{R}{{β}_{offset}^{CSI - 2}} \qquad [ Math . 14 ]$$

Nᵣₑₚ is a number of CSI reports including CSI-Part2 in one slot. The terminal device 1 may, according to the priority order, determine N′_{Rep} CSI-Part2 among the Nᵣₑₚ CSI-Part2. The terminal device 1 multiplexes and transmits the N′_{Rep} CSI-Part2 to the PUSCH. The terminal device 1 may determine Q′_{CSI-2} at least based on a payload size O_{CSI-part2} of the N′_{Rep} CSI-Part2. N′_{Rep} may be a value that satisfies the inequality of mathematical formula 15. N′_{Rep} may be the largest integer that satisfies the inequality of mathematical formula 15. The terminal device 1 may omit (Nᵣₑₚ−Nᵣₑₚ) CSI-Part2 at least based on the priority order. Omitting CSI-Part2 may signify that a size of O_{CSI-2} and/or L_{CSI-2} in mathematical formula 16 becomes smaller. Moreover, omitting CSI-Part2 may signify selecting N′_{Rep} CSI-Part2. Here, a bit count of the N′_{Rep} CSI-Part2 may be the largest value that satisfies mathematical formula 15. Moreover, E_{bit} may be a length E_{UCI} of the rate-matching output sequence corresponding to CSI-Part2. Moreover, E_{bit} may be a reference value for omitting CSI-Part2. E_{bit} may be imparted at least based on CSI-Part2 not being omitted. Moreover, O_{CSI-2,n} is a bit count of an nth report when one CSI-Part2 report or a plurality thereof is arranged in the priority order, and a smaller n may signify a higher priority order.

$$\begin{matrix}{c}_{T} \underline{>} {c}_{act} ( {N}_{Rep}^{′} ) & [ Math . 15 ] \\ {c}_{act} ( {N}_{Rep}^{′} ) = \frac{{\sum }_{n = 1}^{{N}_{Rep}^{′}} {O}_{CSI - 2 , n} + {L}_{CSI - 2}}{{E}_{bit}} & [ Math . 16 ]\end{matrix}$$

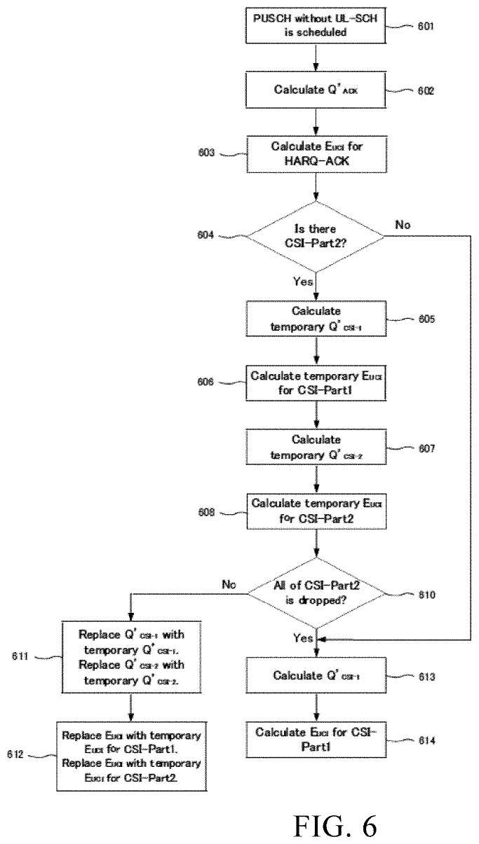

FIG. 6 is a diagram illustrating a flowchart that derives a number of coded modulation symbols of a UCI payload transmitted in the PUSCH not accompanied by the UL-SCH in the present embodiment. When the PUSCH not accompanied by the UL-SCH is scheduled in the terminal device 1 at 601, at 602, the terminal device 1 derives the number Q′_{ACK} of coded modulation symbols corresponding to the HARQ-ACK at least based on mathematical formula 2. At 603, the length of the rate-matching output sequence for the HARQ-ACK may be imparted at least based on Q′_{ACK} derived at 602. Moreover, at 603, the rate-matching output sequence for the HARQ-ACK may be imparted at least based on mathematical formula 10.

At 604, it may be determined whether CSI-Part2 is included in the UCI payload. If CSI-Part2 is included in the UCI payload, the flow proceeds to 605. If CSI-Part2 is not included in the UCI payload, the flow proceeds to 613.

At 605, the number Q′_{CSI-1} of temporary (temporary) coded modulation symbols for CSI-Part1 may be calculated. This number Q′_{CSI-1} of temporary coded modulation symbols at 605 may be imparted at least based on mathematical formula 4. This number Q′_{CSI-1} of temporary coded modulation symbols may differ from or be identical to an actual number of coded modulation symbols. This number Q′_{CSI-1} of temporary coded modulation symbols may be derived by assuming that CSI-Part2 is not dropped. Here, CSI-Part2 being dropped may be CSI-Part2 not being multiplexed in the PUSCH. Moreover, CSI-Part2 being dropped may be CSI-Part2 not being mapped onto the PUSCH.

At 606, a length of a temporary rate-matching output sequence of CSI-Part1 may be determined at least based on the number Q′_{CSI-1} of temporary coded modulation symbols determined at 605. At 606, the length of the temporary rate-matching output sequence of CSI-Part1 may be determined at least based on mathematical formula 11.

At 607, the number Q′_{CSI-2} of temporary (temporary) coded modulation symbols for CSI-Part2 may be calculated. This number Q′_{CSI-2} of temporary coded modulation symbols at 607 may be imparted at least based on mathematical formula 8. This number Q′_{CSI-2} of temporary coded modulation symbols may differ from or be identical to an actual number of coded modulation symbols. This number Q′_{CSI-2} of temporary coded modulation symbols may be derived by assuming that CSI-Part2 is not dropped.

At 608, a length of a temporary rate-matching output sequence of CSI-Part2 may be determined at least based on the number Q′_{CSI-2} of temporary coded modulation symbols determined at 607. At 608, the length of the temporary rate-matching output sequence of CSI-Part2 may be determined at least based on mathematical formula 12. The length of the temporary rate-matching output sequence of CSI-Part2 may be the reference value for omitting CSI-Part2.

At 610, it is determined whether all CSI-Part2 is dropped. If all CSI-Part2 is dropped, the flow proceeds to 613. If all CSI-Part2 is not dropped, the flow proceeds to 611. That is, if a portion of CSI-Part2 is dropped, the flow proceeds to 611. If CSI-Part2 is not dropped, the flow proceeds to 611. If CSI-Part2 is present even after dropping is performed, the flow proceeds to 611.

At 611, the number of temporary coded modulation symbols for CSI-Part1 may be set to the number of coded modulation symbols for CSI-Part1. Moreover, at 612, the length of the temporary rate-matching output sequence for CSI-Part1 may be set to the length of the rate-matching output sequence for CSI-Part1. At 611, the number of temporary coded modulation symbols for CSI-Part2 may be set to the number of coded modulation symbols for CSI-Part2. Moreover, at 612, the length of the temporary rate-matching output sequence for CSI-Part2 may be set to the length of the rate-matching output sequence for CSI-Part2.

At 613, the terminal device 1 may calculate the number Q′_{CSI-1} of coded modulation symbols by assuming that CSI-Part2 is not present. The length of the rate-matching output sequence of CSI-Part1 may be imparted at least based on the number Q′_{CSI-1} of coded modulation symbols calculated at 613. At 613, the length of the rate-matching output sequence of CSI-Part1 may be imparted by assuming that CSI-Part2 is not present. CSI-Part2 not being present may be CSI-Part2 not being transmitted in the PUSCH.

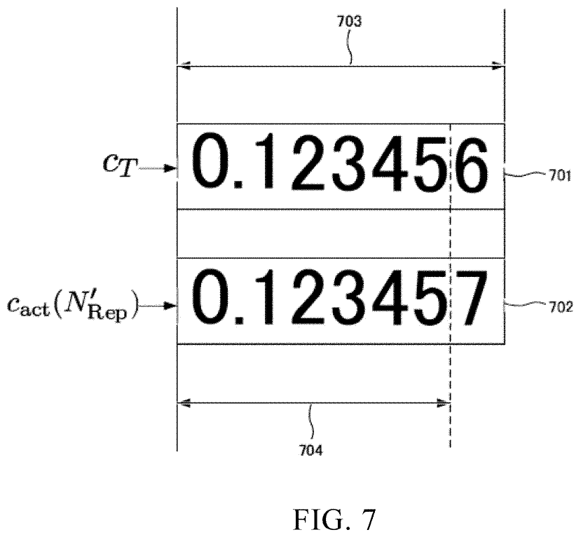

FIG. 7 is a diagram illustrating one example of decimal calculation performances of the terminal device 1 and the base-station device 3 in the present embodiment. 701 may be the threshold code rate c_{T} corresponding to CSI-Part2. 702 may be the actual code rate of CSI-Part2. Moreover, 703 may be the decimal calculation performance of the base-station device 3. 704 may be the decimal calculation performance of the terminal device 1. Here, the decimal calculation performance is a performance of being able to calculate decimal values. This may signify that the greater a number of decimal places, the higher the calculation performance. That is, in FIG. 7, the decimal calculation performance of the base-station device 3 is higher than the decimal calculation performance of the terminal device 1.

As illustrated in FIG. 7, the decimal calculation performance of the terminal device 1 satisfies the inequality given in mathematical formula 15, but the decimal calculation performance of the base-station device 3 does not satisfy the inequality given in mathematical formula 15. That is, there is a problem wherein the threshold code rate c_{T} derived from mathematical formula 13 and/or mathematical formula 14 may or may not satisfy the inequality of mathematical formula 15, depending on the decimal calculation performance of the device. Moreover, there is a problem wherein the actual code rate derived from c_{act}(N′_{Rep}) given in mathematical formula 16 may or may not satisfy the inequality of mathematical formula 15, depending on the decimal calculation performance of the device.

As given in mathematical formula 17, the terminal device 1 may perform dropping by converting the threshold code rate and the actual code rate into integers. Here, intA(F₃) or intB(F₃) may be a function that converts a number F₃ having a decimal value into an integer. Moreover, intA(F₃) or intB(F₃) may be a floor(F₃) function, a ceil(F₃) function, or a function that outputs an integer by rounding in order from a zth decimal place to the first decimal place. Here, z may be an integer equal to or greater than 1. For example, for the decimal 10.45445, if z=5 (fifth decimal place), the result of the rounding may be 11. intA( ) and intB( ) may be output using functions of the same type or output using functions of different types. x₁ may be a number greater than 0. Moreover, it may be 1, 1,000, 1,024, or 10^{x}. Here, if x is 3, the relationship may be such that 10^{x}=1,000 or x₁=1,000. For example, in one example of cT and c_{act}(N′_{Rep}) illustrated in FIG. 7, this may be such that if x₁=10^{x}, x=5, intA( )=floor( ), and intB( )=floor( ), intA(c_{T}·10^{x})=12,345 and intB(c_{act}(N′_{Rep})·10^{x})=12,345. N′_{Rep} may be a value that satisfies the inequality given in mathematical formula 17. Moreover, N′_{Rep} may be the largest value that satisfies the inequality given in mathematical formula 17.

intA(c_{T}·x₁)≥intB(c_{act}(N_{Rep}′)·x₁) [Math. 17]

As a method of determining the largest value that satisfies the inequality, the max function that outputs the largest value given in mathematical formula 18 may be used. For example, mathematical formula 18 gives a method of determining the largest value of N′_{Rep} in mathematical formula 17 using a max function. Here, maxₐ₁ {condition} is a function that outputs the largest value of a1 that satisfies the condition. Mathematical formula 18 is a function that inputs mathematical formula 17 as the condition and outputs the largest value of N′_{Rep} that satisfies this condition. Note that when a1 is the largest value that satisfies the condition, a1+1 does not need to satisfy the condition.

$${max}_{{N}_{Rep}^{′}} ( intA ( {c}_{T} \cdot {x}_{1} ) \underline{>} intB ( {c}_{a c t} ( {N}_{Rep}^{′} ) \cdot {x}_{1} ) ) \qquad [ Math . 18 ]$$

In the method of determining the largest value that satisfies the inequality, the largest value may be determined from among values obtained while changing the variables in the inequality. For example, the method of determining the largest value of N′_{Rep} in mathematical formula 17 may be a method that simultaneously satisfies the inequalities given in mathematical formula 19 and mathematical formula 20. For example, the terminal device 1 may determine an N′_{Rep} that simultaneously satisfies the inequalities given in mathematical formula 19 and mathematical formula 20 as the largest value of N′_{Rep}. That is, the terminal device 1 may determine, as the largest value of N′_{Rep} in this inequality, a value of N′_{Rep} that causes the inequality sign to switch directions between N′_{Rep} and N′_{Rep}+1.

intA(c_{T}·x₁)<intB(c_{act}(N_{Rep}′+1)·x₁) [Math. 19]

intA(c_{T}·x₁)≥intB(c_{act}(N_{Rep}′)·x₁) [Math. 20]

The terminal device 1 may determine an N′_{Rep} that satisfies the inequality given in mathematical formula 21, mathematical formula 22, mathematical formula 23, mathematical formula 24, mathematical formula 25, mathematical formula 26, mathematical formula 27, mathematical formula 28, mathematical formula 29, mathematical formula 30, mathematical formula 31, or mathematical formula 32. The terminal device 1 may determine the largest N′_{Rep} that satisfies the inequality given in mathematical formula 21, mathematical formula 22, mathematical formula 23, mathematical formula 24, mathematical formula 25, mathematical formula 26, mathematical formula 27, mathematical formula 28, mathematical formula 29, mathematical formula 30, mathematical formula 31, or mathematical formula 32. Here, x₃ may be a number greater than 0. For example, x₃ may be 1, 1,000, or 1,024.

$$\begin{matrix} intA ( \frac{{c}_{act} ( {N}_{Rep}^{′} )}{{c}_{T}} \cdot {x}_{3} ) \underline{<} {x}_{3} & [ Math . 21 ] \\ intA ( \frac{{c}_{T}}{{c}_{act} ( {N}_{Rep}^{′} )} \cdot {x}_{3} ) \underline{>} {x}_{3} & [ Math . 22 ] \\ {c}_{MCS} \cdot {x}_{3} \underline{>} {β}_{offset}^{CSI - 2} \cdot ( \frac{{\sum }_{n = 1}^{{N}_{Rep}^{′}} {O}_{CSI - 2 , n} + {L}_{CSI - 2}}{{E}_{bit}} ) \cdot {x}_{3} & [ Math . 23 ] \\ intA ( {c}_{MCS} \cdot {x}_{3} ) \underline{>} intB ( {β}_{offset}^{CSI - 2} \cdot ( \frac{{\sum }_{n = 1}^{{N}_{Rep}^{′}} {O}_{CSI - 2 , n} + {L}_{CSI - 2}}{{E}_{bit}} ) \cdot {x}_{3} ) & [ Math . 24 ] \\ {c}_{MCS} \cdot {E}_{bit} \cdot {x}_{3} \underline{>} {β}_{offset}^{CSI - 2} \cdot ( {\sum }_{n = 1}^{{N}_{Rep}^{′}} {O}_{CSI - 2 , n} + {L}_{CSI - 2} ) \cdot {x}_{3} & [ Math . 25 ] \\ intA ( {c}_{MCS} \cdot {E}_{bit} \cdot {x}_{3} ) \geq intB ( {β}_{offset}^{CSI - 2} \cdot ( {\sum }_{n = 1}^{{N}_{Rep}^{′}} {O}_{CSI - 2 , n} + {L}_{CSI - 2} ) \cdot {x}_{3} ) & [ Math . 26 ] \\ \frac{{c}_{MCS} \cdot E}{{β}_{offset}^{CSI - 2}} \cdot {x}_{3} \underline{>} ( {\sum }_{n = 1}^{{N}_{Rep}^{′}} {O}_{CSI - 2 , n} + {L}_{CSI - 2} ) \cdot {x}_{3} & [ Math . 27 ] \\ intA ( \frac{{c}_{MCS} \cdot {E}_{bit}}{{β}_{offset}^{CSI - 2}} \cdot {x}_{3} ) \underline{>} intB ( ( {\sum }_{n = 1}^{{N}_{Rep}^{′}} {O}_{CSI - 2 , n} + {L}_{CSI - 2} ) \cdot {x}_{3} ) & [ Math . 28 ] \\ \frac{{c}_{MCS} \cdot {E}_{b i t}}{( {\sum }_{n = 1}^{{N}_{Rep}^{′}} {O}_{CSI - 2 , n} + {L}_{CSI - 2} )} \cdot {x}_{3} \underline{>} {β}_{offset}^{CSI - 2} \cdot {x}_{3} & [ Math . 29 ] \\ intA ( \frac{{c}_{MCS} \cdot {E}_{bit}}{( {{\sum }^{{N}_{Rep}^{′}}}_{n = 1} {O}_{CSI - 2 , n} + {L}_{CSI - 2} )} \cdot {x}_{3} ) \geq intB ( {β}_{offset}^{CSI - 2} \cdot {x}_{3} ) & [ Math . 30 ] \\ {E}_{bit} \cdot {x}_{3} \underline{>} \frac{{β}_{offset}^{CSI - 2} \cdot ( {\sum }_{n = 1}^{{N}_{Rep}^{′}} {O}_{CSI - 2 , n} + {L}_{C S I - 2} )}{{c}_{MCS}} \cdot {x}_{3} \\ intA ( {E}_{bit} \cdot {x}_{3} ) \geq intB ( \frac{{β}_{offset}^{CSI - 2} \cdot ( {\sum }_{n = 1}^{{N}_{Rep}^{′}} {O}_{CSI - 2 , n} + {L}_{CSI - 2} )}{{c}_{MCS}} \cdot {x}_{3} ) & [ Math . 31 ]\end{matrix}$$

Note that mathematical formula 21, mathematical formula 22, mathematical formula 23, mathematical formula 24, mathematical formula 25, mathematical formula 26, mathematical formula 27, mathematical formula 28, mathematical formula 29, mathematical formula 30, mathematical formula 31, or mathematical formula 32 may each be input as the condition for seeking the largest value of N′_{Rep} in mathematical formula 18.

Furthermore, respectively in mathematical formula 21, mathematical formula 22, mathematical formula 23, mathematical formula 24, mathematical formula 25, mathematical formula 26, mathematical formula 27, mathematical formula 28, mathematical formula 29, mathematical formula 30, mathematical formula 31, or mathematical formula 32, when the inequality sign switches directions between N′_{Rep} and N′_{Rep}+1 (the inequality relationship is inverted in each formula between N′_{Rep} and N′_{Rep}+1 and/or sizes of values respectively obtained on the left side and the right side are inverted between N′_{Rep} and N′_{Rep}+1), the terminal device 1 may determine this value of N′_{Rep} to be the largest value of N′Rₑₚ.

c_{MCS} may be imparted by dividing a value C_{mcs} given by an MCS index included in the DCI format by 1,024. That is, C_{mcs} may be defined as the product of the target code rate c_{MCS} and 1,024. C_{mcs} may be an integer value defined as the product of the target code rate c_{MCS} and 1,024. Even if C_{mcs} is an integer value, c_{MCS} is a decimal. Therefore, depending on the decimal calculation performances of the terminal device 1 and the base-station device 3, the value of c_{MCS} in the terminal device 1 may differ from the value of c_{MCS} in the base-station device 3.

Therefore, respectively in mathematical formula 21, mathematical formula 22, mathematical formula 23, mathematical formula 24, mathematical formula 25, mathematical formula 26, mathematical formula 27, mathematical formula 28, mathematical formula 29, or mathematical formula 30, x₃ may be 1,024, and c_{MCS}·x₃ may be substituted by C_{mcs}.

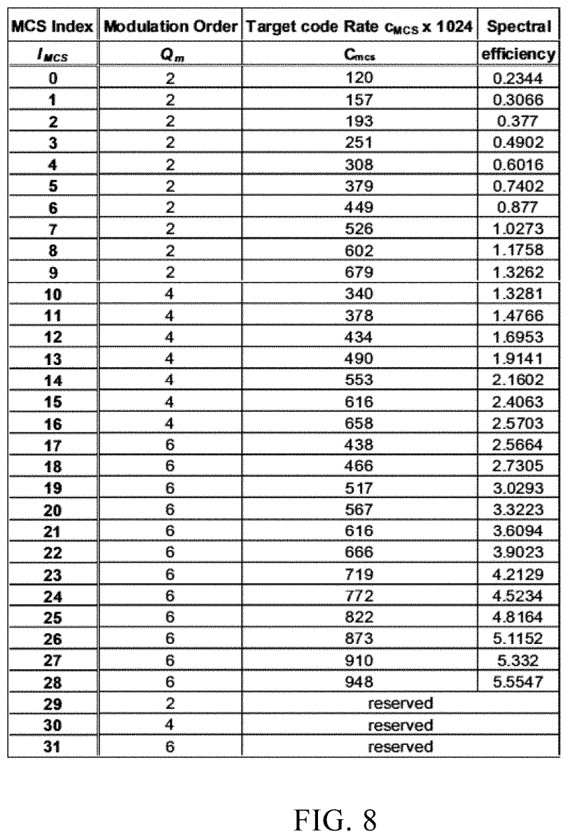

FIG. 8 is a diagram illustrating one example of candidates of C_{mcs} imparted at least based on the DCI format in the present embodiment. In FIG. 8, the terminal device 1 may set a value corresponding to the MCS index included in the DCI format to C_{mcs}. For example, when the MCS index included in the DCI format is 5, the terminal device 1 may set C_{mcs} to 379.

This makes it unnecessary for the terminal device 1 and the base-station device 3 to calculate a decimal c_{MCS} in mathematical formula 21, mathematical formula 22, mathematical formula 23, mathematical formula 24, mathematical formula 25, mathematical formula 26, mathematical formula 27, mathematical formula 28, mathematical formula 29, or mathematical formula 30, respectively. Depending on the decimal calculation performances of the terminal device 1 and the base-station device 3, the possibility is eliminated of the value of c_{MCS} in the terminal device 1 differing from the value of c_{MCS} in the base-station device 3.

Various aspects of the terminal device 1 and the base-station device 3 in the present embodiment are described below.

(1) A first aspect of the present embodiment is a terminal device, provided with: a transmission unit that transmits performance information and/or a PUSCH of the terminal device; wherein CSI-Part2 that is multiplexed in the PUSCH is dropped until a code rate of the CSI-Part2 becomes equal to or less than a target code rate of the CSI-Part2, and the code rate of the CSI-Part2 is determined based on a calculation performance of decimal places supported in the performance information of the terminal device.

(2) A second aspect of the present embodiment is a base-station device, provided with: a reception unit that receives performance information and/or a PUSCH of a terminal device; wherein it is assumed that CSI-Part2 that is multiplexed in the PUSCH is dropped until a code rate of the CSI-Part2 becomes equal to or less than a target code rate of the CSI-Part2, and comparison is performed by taking into account a number of decimal places relating to the code rate and the target code rate based on the performance information of the terminal device.

This enables the terminal device 1 and the base-station device 3 to communicate efficiently.

A program that operates on the base-station device 3 and the terminal device 1 relating to the present invention may be a program that controls a CPU (central processing unit) or the like (program that causes a computer to function) so the functions of the above embodiment relating to the present invention are realized. Moreover, information handled by these devices is temporarily stored in a RAM (random-access memory) when being processed. Afterward, it is stored in various ROM (read-only memories) such as a flash ROM or an HDD (hard disk drive) and read, revised, and written by a CPU as necessary.

Note that a portion of the terminal device 1 and the base-station device 3 in the above embodiment may be realized by a computer. In this situation, this may be realized by recording this program for realizing the control functions on a computer-readable recording medium and causing a computer system to read and execute this program recorded on the recording medium.

Note that the “computer system” referred to here is a computer system built into the terminal device 1 or the base-station device 3 and includes an OS and hardware such as peripherals. Moreover, the “computer-readable recording medium” refers to a portable medium such as a flexible disk, a magneto-optical disk, a ROM, or a CD-ROM; a hard disk built into the computer system; or another storage device.

Furthermore, the “computer-readable recording medium” may include a medium that dynamically holds the program for a short time, such as a communication line when transmitting the program via a network such as the internet or a communication circuit such as a phone circuit, and a medium that holds the program for a certain time, such as a volatile memory inside the computer system serving as a server or a client in this situation. Moreover, the above program may be for realizing a portion of the above functions and may also be able to realize the above functions in combination with a program already recorded on the computer system.

Furthermore, the base-station device 3 in the above embodiment can also be realized as an aggregate (device group) constituted from a plurality of devices. Each device constituting the device group may be provided with a portion or an entirety of the functions or the functional blocks of the base-station device 3 relating to the above embodiment. It is sufficient for the device group to have a set of functions or functional blocks of the base-station device 3. Moreover, the terminal device 1 relating to the above embodiment can also communicate with the aggregate base-station devices.

Furthermore, the base-station device 3 in the above embodiment may be a EUTRAN (Evolved Universal Terrestrial Radio Access Network). Moreover, the base-station device 3 in the above embodiment may have a portion or an entirety of the functions of a host node for an eNodeB.

Furthermore, a portion or an entirety of the terminal device 1 and the base-station device 3 in the above embodiment may be realized as an LSI, which is typically an integrated circuit, or a chipset. Each functional block of the terminal device 1 and the base-station device 3 may be made into chips individually or made into a chip by integrating a portion or an entirety thereof. Moreover, a method of circuit integration is not limited to LSI and may be realized by a dedicated circuit or a general-purpose processor. Moreover, when advancements in semiconductor art produce circuit-integration art that replaces LSI, an integrated circuit using such art can also be used.

Furthermore, although the above embodiment describes a terminal device as one example of a communication device, the invention of the present application is not limited thereto and can also be applied as a terminal device or a communication device of stationary or nonmobile electronic equipment disposed indoors or outdoors—for example, AV equipment, kitchen equipment, cleaning and laundry equipment, air conditioning equipment, office equipment, a vending machine, or other consumer equipment.

An embodiment of this invention is detailed above with reference to the drawings. However, a specific configuration is not limited to this embodiment and also includes design changes and the like of a scope that does not depart from the spirit of this invention. Moreover, the present invention can be changed in various ways within the scope indicated in the claims, and embodiments obtained by appropriately combining technical means respectively disclosed in different embodiments are also included in the technical scope of the present invention. Moreover, configurations that substitute elements that are described in the above embodiments and exhibit similar effects are also included.

1. A terminal device, comprising:
a transmission unit configured to transmit a physical uplink shared channel (PUSCH) scheduled by a downlink control information (DCI), wherein:
a plurality of first channel state information (CSI)-Part2 reports of a plurality of second CSI-Part2 reports are multiplexed in the PUSCH;
a number of the first CSI-Part2 reports (N′_{Rep}) is a largest value satisfying
$${c}_{MCS} \cdot {E}_{bit} \cdot {x}_{3} \geq {β}_{offset}^{CSI - 2} \cdot ( {\sum }_{n = 1}^{{N}_{Rep}^{′}} {O}_{CSI - 2 , n} + {L}_{CSI - 2} ) \cdot {x}_{3}$$
c_{MCS} is a target code rate of the PUSCH;
E_{bit} is a length of a rate-matching output sequence corresponding to the first CSI-Part2 reports;
β_{offset}^{CSI-2} is an offset value for determining a number of resources to use in multiplexing the first CSI-Part2 reports in the PUSCH;
O_{CSI-2,n} is a bit count of an n^{th} CSI-Part2 report of the first CSI-Part2 reports;
L_{CSI-2} is a cyclic redundancy check (CRC) bit count corresponding to O_{CSI-2,n}; and
x₃ is an integer larger than 0.

2-4. (canceled)

5. The terminal device of claim 1, wherein x₃ is equal to 1024.

6. The terminal device of claim 1, wherein the transmission unit is further configured to receive the DCI that triggers multiplexing of the first CSI-Part2 reports in the PUSCH.

7. The terminal device of claim 1, wherein the PUSCH is not accompanied by uplink data.

8. The terminal device of claim 1, wherein the transmission unit is further configured to divide each of a plurality of CSI reports into multiple parts and each of the first CSI-Part2 reports is a second part of the multiple parts.

9. The terminal device of claim 1, wherein the transmission unit is further configured:
to drop the first CSI-Part2 reports multiplexed in the PUSCH until a code rate of the first CSI-Part2 reports becomes equal to or less than a target code rate of the first CSI-Part2 reports; and
to determine the code rate of the first CSI-Part2 reports based on a decimal calculation capability supported in capability information of the terminal device.

10. The terminal device of claim 9, wherein the decimal calculation capability is related to an ability to calculate decimal values.

11. The terminal device of claim 9, wherein the code rate of the first CSI-Part2 reports is identical to the target code rate of the first CSI-Part2 reports.

12. The terminal device of claim 9, wherein the code rate of the first CSI-Part2 reports is different from the target code rate of the first CSI-Part2 reports.

13. A base-station device, comprising:
a reception unit configured to receive a physical uplink shared channel (PUSCH) transmitted by a terminal device, wherein:
a plurality of first channel state information (CSI)-Part2 reports of a plurality of second CSI-Part2 reports are multiplexed in the PUSCH;
a number of the first CSI-Part2 reports (N′_{Rep}) is a largest value satisfying
$${c}_{MCS} \cdot {E}_{bit} \cdot {x}_{3} \underline{>} {β}_{offset}^{CSI - 2} \cdot ( {\sum }_{n = 1}^{{N}_{Rep}^{′ \cdot }} {O}_{CSI - 2 , n} + {L}_{CSI - 2} ) \cdot {x}_{3} ;$$
c_{MCS} is a target code rate of the PUSCH;
E_{bit} is a length of a rate-matching output sequence corresponding to the first CSI-Part2 reports;
β_{offset}^{CSI-2} is an offset value for determining a number of resources to use in multiplexing the first CSI-Part2 reports in the PUSCH;
O_{CSI-2,n} is a bit count of an n^{th} CSI-Part2 report of the first CSI-Part2 reports;
L_{CSI-2} is a cyclic redundancy check (CRC) bit count corresponding to O_{CSI-2,n}; and
x₃ is an integer larger than 0.

14. The base-station device of claim 13, wherein x₃ is equal to 1024.

15. The base-station device of claim 13, wherein the reception unit is further configured to transmit a downlink control information (DCI) that schedules the PUSCH and that triggers multiplexing of the first CSI-Part2 reports in the PUSCH.

16. The base-station device of claim 13, wherein the PUSCH is not accompanied by uplink data.

17. The base-station device of claim 13, wherein each of a plurality of CSI reports is divided into multiple parts and each of the first CSI-Part2 reports is a second part of the multiple parts.

18. A communication method performed by a terminal device, comprising:
transmitting a physical uplink shared channel (PUSCH) scheduled by a downlink control information (DCI), wherein:
a plurality of first channel state information (CSI)-Part2 reports of a plurality of second CSI-Part2 reports are multiplexed in the PUSCH;
a number of the first CSI-Part2 reports (N′_{Rep}) is a largest value satisfying
$${c}_{MCS} \cdot {E}_{bit} \cdot {x}_{3} \underline{>} {β}_{offset}^{CSI - 2} \cdot ( {\sum }_{n = 1}^{{N}_{Rep}^{′}} {O}_{CSI - 2 , n} + {L}_{CSI - 2} ) \cdot {x}_{3} ;$$
c_{MCS} is a target code rate of the PUSCH;
E_{bit} is a length of a rate-matching output sequence corresponding to the first CSI-Part2 reports;
β_{offset}^{CSI-2} is an offset value for determining a number of resources to use in multiplexing the first CSI-Part2 reports in the PUSCH;
O_{CSI-2,n} is a bit count of an n^{th} CSI-Part2 report of the first CSI-Part2 reports;
L_{CSI-2} is a cyclic redundancy check (CRC) bit count corresponding to O_{CSI-2,n}; and
x₃ is an integer larger than 0.

19. The communication method of claim 18, wherein x is equal to 1024.

20. The communication method of claim 18, further comprising receiving the DCI that triggers multiplexing of the first CSI-Part2 reports in the PUSCH.

21. The communication method of claim 18, wherein the PUSCH is not accompanied by uplink data.

22. The communication method of claim 18, further comprising dividing each of a plurality of CSI reports into multiple parts, wherein each of the first CSI-Part2 reports is a second part of the multiple parts.

23. The communication method of claim 18, further comprising:
dropping the first CSI-Part2 reports multiplexed in the PUSCH until a code rate of the first CSI-Part2 reports becomes equal to or less than a target code rate of the first CSI-Part2 reports; and
determining the code rate of the first CSI-Part2 reports based on a calculation capability of decimal places supported in capability information of the terminal device.
